(19) United States
(12) Patent Application Publication
(10) Pub. No.: US 2023/0198976 A1
(43) Pub. Date: Jun. 22, 2023

(54) DEVICES AND METHODS FOR INCORPORATING A DEVICE INTO A LOCAL AREA NETWORK

(71) Applicant: BSH Hausgeräte GmbH, München (DE)

(72) Inventors: Matthias Jahner, Waging am See (DE); Christoph Söllner, München (DE)

(21) Appl. No.: 18/007,591

(22) PCT Filed: May 25, 2021
(86) PCT No.: PCT/EP2021/063792

§ 371 Date: Dec. 1, 2022

(30) Foreign Application Priority Data
Jun. 4, 2020 (DE) 10 2020 207 033.4

(51) Int. Cl. H04L 9/40

(52) U.S. Cl. CPC H04L 63/0823; H04L 63/102; H04L 63/0876

(57) ABSTRACT

A method incorporates a device into a LAN, wherein the device has a certificate which was derived from a device reference certificate. The method includes checking whether the certificate of the device matches at least one reference certificate, which is available at a first access point to a first LAN. The method furthermore contains the incorporation of the device into the first LAN when it is determined that the certificate of the device matches at least one reference certificate available at the first access point.

The invention relates to the efficient, reliable and convenient incorporation of an appliance, in particular a household appliance, into a local area network (LAN).

When a user brings a new, LAN-compatible, appliance home, in particular a new household appliance, said user typically first has to spend a relatively long period of time in incorporating said appliance into his or her LAN.

The present document deals with the technical object of facilitating an especially convenient, reliable and secure incorporation of a LAN-compatible appliance into a LAN.

The object is achieved in each case by the subject matters of the independent claims. Advantageous forms of embodiment are defined in particular in the dependent claims, are described in the following description or are represented in the attached drawing.

In accordance with one aspect of the invention a method (if applicable a computer-implemented method) for incorporating an appliance into a local area network (LAN), in particular into a wireless LAN, is described. The appliance can in particular be a household appliance, such as an oven, a refrigerator, a stove, a dishwasher, a washing machine, a dryer, a food processor, a coffee machine, etc. The appliance can comprise a communication module which is designed to set up a wired and/or a wireless LAN connection (in particular in accordance with IEEE 802.11) to access point. The method can be embodied by a (first) access point.

The appliance has a certificate which was derived from aa appliance reference certificate. The certificate can in this case be deduced from the appliance reference certificate along an appliance certificate chain via one or more intermediate certificates. In this case the appliance reference certificate can be assigned to a particular entity (e.g. the manufacturer of the appliance). Different certificates can then be generated from the appliance reference certificate for different appliance of the entity and can be provided on the respective appliance. In this case the certificate can in each can be stored on a storage unit, in particular on a trusted platform module (TPM), or another storage solution deemed to be secure, of the respective appliance. The appliance can be designed to determine the appliance certificate chain from the certificate of the appliance, and/or the appliance can be designed to provide the appliance certificate chain in whole or in part. The appliance certificate chain can for example be stored on the appliance.

The reference certificate of an entity can be the root certificate of the entity or a certificate derived from the root certificate of the entity. In this document the term “appliance reference certificate” of an appliance means the reference certificate of an entity from which the certificate of the appliance (i.e. the certificate that is stored on the appliance and/or that was assigned to the appliance) was derived. The appliance reference certificate thus relates to a particular reference certificate of a particular entity (especially the particular entity to which the appliance is assigned).

The method comprises checking whether the certificate of the appliance matches at least one reference certificate that is available at a first access point to a first (W)LAN. In particular, on the basis of the certificate of the appliance it is possible to check whether the appliance reference certificate (i.e. the reference certificate from which the certificate of the appliance was derived) is available at the first access point, in particular whether the appliance reference certificate is stored on a storage unit, for instance on a TPM or another storage solution deemed to be secure, of the first access point.

It is possible for example for a list containing one or more reference certificates (if applicable of different entities) to be available at the first access point. This list can for example be provided in the first access point during the manufacture of the first access point. In particular the list containing one or more reference certificates can be stored on a storage unit, in particular on a TPM, of the first access point. It is then possible to check in an efficient and reliable manner whether or not the appliance reference certificate is included in the list containing one or more reference certificates and/or whether the certificate of the appliance was derived from one of the reference certificates in the list (along a reference chain).

The method further comprises incorporating the appliance into the first (W)LAN, if it is determined that the certificate of the appliance was derived from at least one reference certificate available at the first access point. The incorporation of the appliance into the first LAN can take place if, in particular only if, it is determined that the appliance reference certificate (i.e. the reference certificate from which the certificate of the appliance was derived) is included in the list containing one or more reference certificates, or if, in particular only if, it is determined that the appliance reference certificate is available at the access point, or if, in particular only if, it is determined that the certificate of the appliance was derived from a reference certificate available at the first access point (and is valid in terms of information security).

The method enables an appliance to be incorporated into a (W)LAN in an efficient, convenient and secure manner. The incorporation can in this case take place automatically, without access data (such as e.g. a pre-shared key (PSK)) to the LAN having to be input by a user. The incorporation can e.g. take place automatically during commissioning of the appliance.

The method can comprise the determination of one or more network units, for which an access authorization of the appliance via the first LAN is present. The one or more network units can in this case be arranged in a wide area network (WAN) outside the first LAN (e.g. on the Internet). The one or more network units can be included in the list stored at the first access point. The one or more network units can be operated or provided by the entity to which the appliance reference certificate is assigned.

The incorporation of the appliance into the first LAN can be restricted to access to the one or more network units. In particular the first access point can be configured so that the appliance can only access the one or more network units, and otherwise has no further access to components of the first LAN or to other components of the WAN. Thus the security of the (automatic) incorporation of the appliance can be further increased.

The method can comprise the provision of a communication link between the appliance and the one or more network units via the first access point, in particular via a router of the first access point. The communication link can then for example be used for the remote maintenance of the appliance (starting from the one or more network units). An appliance manufacturer can thus be enabled to access appliance in an efficient and reliable manner (since the appliance automatically connect to the one or more network units (e.g. servers) of the manufacturer).

As already set out above, a list containing one or more reference certificates can be available, in particular stored, at the first access point. For each of the reference certificates (and for each entity associated therewith) the list can in each case indicate at least one network unit for which appliances having a certificate matching the respective reference certificate have an access authorization. Thus different entities can be enabled in an efficient and secure manner to access the appliances of the respective entity.

The method can comprise the determination of the appliance certificate chain between the certificate of the appliance and the appliance reference certificate, wherein the appliance certificate chain indicates one or more intermediate certificates between the certificate of the appliance and the appliance reference certificate. The appliance certificate chain can be sent in whole or in part e.g. by the appliance to the first access point and received by the first access point. It is then possible to check in a particularly efficient and precise manner on the basis of the appliance certificate chain whether the certificate of the appliance matches at least one reference certificate that is available at the first access point to the first LAN.

The first access point can if applicable be any access point, in the receiving range of which the appliance is located. For example, in an urban environment the first access point can be operated by a neighbor of the user of the appliance.

A first (temporary and/or restricted) access to a LAN and via this to a WAN can be enabled by the first access point. For full access to a LAN and/or to a WAN it may be necessary for the appliance to be connected (automatically) to a second access point (e.g. to an access point of the user).

As already set out above, the method can comprise the determination of at least one network unit, for which an access authorization of the appliance via the first LAN is present. In this case the network unit can indicate at least one second access point to a second LAN. This information can for example be stored on the network unit in a user account of the user of the appliance. The access data to the second access point can be stored in the user account (e.g. the PSK to the second access point).

A communication link between the appliance and the network unit via the first access point can then be set up, to enable the appliance to obtain the access data to the second access point from the network unit. Thus an automatic “reassignment” of the appliance from the first LAN to a second LAN can be enabled, in particular in order if applicable to give the appliance within the second LAN unrestricted access to a LAN and/or to the WAN (for instance the Internet). Thanks to the automatic incorporation into a second LAN the convenience for the user can be further increased. The incorporation into the second LAN can for example be carried out to enable the user to remotely control the appliance (e.g. with a user device, for instance the user's smartphone, that is incorporated into the second LAN).

For example, in the context of the method it is possible to check whether remote control of the appliance should take place using a user appliance. The LAN into which the user device is incorporated can then be determined. In particular it is possible to determine that the user appliance is incorporated into the second LAN via the second access point. It is then possible automatically to cause the appliance to be incorporated into the second LAN, in order to enable the user appliance to remotely control the appliance. These method steps can for example be executed by an access point and/or by the appliance.

In accordance with a further aspect of the invention a method (if applicable a computer-implemented method) for incorporating an appliance into a LAN is described. The method can be executed by the appliance. In this case the appliance has a certificate (e.g. on a TPM) that was derived from an appliance reference certificate.

The method comprises the identification of a first access point for a first LAN at which a reference certificate is available that matches the certificate of the appliance, in particular that corresponds to the appliance reference certificate. In other words, it is possible to search for a suitable first access point that has the matching reference certificate. The search for a suitable first access point can in this case be initiated automatically by the appliance (without user interaction), e.g. during first commissioning of the appliance.

The method further comprises the incorporation of the appliance into the first LAN via the first access point. For this purpose the appliance can be connected to the first access point. Access (if applicable restricted access) to the first LAN and/or to the WAN can then be enabled from the access point. Thus convenient and secure access of the appliance to a LAN and/or to a WAN can be enabled.

The method comprises accessing a network unit via the first access point. In this case the network unit can (as already set out above) indicate at least one second access point to a second LAN. Access data (e.g. a PSK) to the second access point can then be obtained from the network unit.

The appliance can then (automatically) be incorporated into the second LAN (and via the second access point into the WAN) via the second access point using the access data to the second access point. On the other hand the appliance can (automatically) be logged off from the first access point. Thus access (if applicable full access) to a second LAN (e.g. to the LAN of the user) and via this to the WAN can be enabled in a particularly convenient and secure manner.

The method can comprise setting up a communication link to a network unit via the first access point. The method can further comprise carrying out maintenance work on the appliance because the network unit can access the appliance via the first access point. Thus an entity (e.g. the manufacturer of the appliance) can be enabled to carry out maintenance work in an efficient and secure manner.

In accordance with a further aspect of the invention an access point (i.e. an apparatus) to a LAN is described, wherein the access point is designed to check whether a certificate of an appliance that is to be incorporated into the LAN matches a reference certificate that is available at the access point. The access point is further designed to incorporate the appliance into the LAN if it is determined that the certificate of the appliance matches a reference certificate available at the access point. Furthermore, the access point can be designed to enable at least restricted access to a WAN (e.g. to a restricted list of network units (for instance servers and/or URLs (Uniform Resource Locators)).

The resources that an appliance with a particular certificate of an entity may use in the LAN and/or in the WAN (for instance a connection containing one or more particular parameters such as IP addresses, URLs, protocol variants, port numbers and the like) can be permanently linked at the access point and/or at further routing components of the LAN to a respective reference certificate. Thus it is possible automatically to restrict access based on the affiliation of the appliance to an entity. For example, a household appliance can exclusively be authorized to set up a connection to just one individual server on the Internet, e.g. the backend of the manufacturer of the household appliance.

In a suitable user interface a user or a network administrator can be shown an overview of which reference certificates are available at an access point. Furthermore, the respectively linked authorizations (URLs, servers, protocol variants and the like) can also be displayed here.

The user or administrator can be given the opportunity to download, install, delete, activate and/or deactivate particular reference certificates (from particular entities) via the user interface. By deactivating or removing a reference certificate any authorization of all appliances (assigned to the deleted reference certificate) that are currently connected to the access point typically expires immediately. In particular the connection to the LAN can be interrupted for these appliances.

In accordance with a further aspect of the invention an appliance is described that has a certificate that was derived from an appliance reference certificate. The appliance is designed to identify a first access point for a first LAN at which a reference certificate is available that matches the certificate of the appliance, in particular that corresponds to the appliance reference certificate. The appliance is further designed, in response thereto, to bring about an incorporation into the first LAN via the first access point.

It should be noted that any aspects of the methods and apparatuses described in this document can be combined with one another in multiple ways. In particular the features of the claims can be combined with one another in multiple ways.

The invention is described in greater detail below using exemplary embodiments shown in the attached drawing, in which:

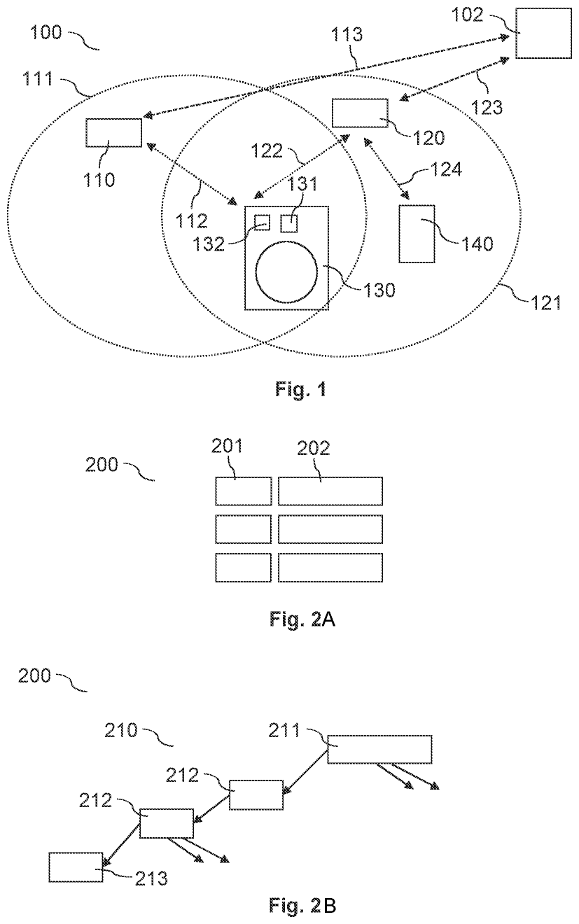

FIG. 1 shows a block diagram of a system for incorporating an appliance into a LAN;

FIG. 2a shows an exemplary certificate list;

FIG. 2b shows an exemplary certificate chain; and

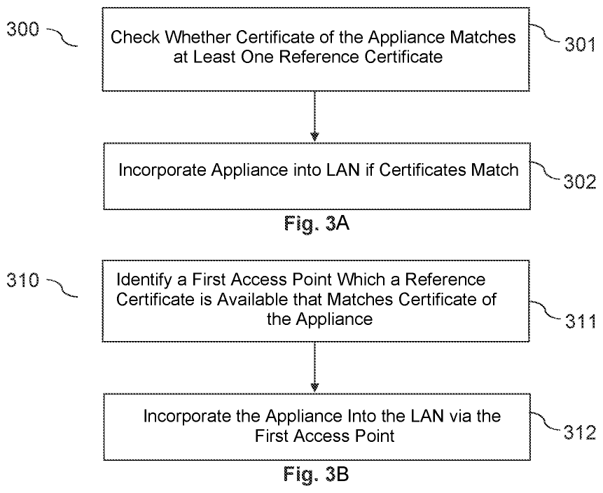

FIGS. 3a and 3b show flow diagrams of exemplary methods for incorporating an appliance into a LAN.

As set out in the introduction, the present document is concerned with the convenient, secure and reliable incorporation of an appliance, in particular a household appliance, into a LAN. In this connection FIG. 1 shows an exemplary system 100 with a LAN-compatible appliance 130. The system 100 comprises a first access point 110 (e.g. a router) to a first (W)LAN 111 and a second access point 120 (e.g. a router) to a second (W)LAN 121. The appliance 130 can comprise a communication module 132 that makes it possible to incorporate the appliance 130 into the first LAN 111 (for a first LAN connection 112) and/or into the second LAN 121 (for a second LAN connection 122). Furthermore, the appliance 130 can have a control module 131 that is designed to control actions of the appliance 130.

The access points 110, 120 can be designed in each case to set up a communication link 113, 123 to a network unit 102 (e.g. to a server, for instance in a cloud) in a wide area network, WAN, (e.g. the Internet). The LANs 111, 121 can include, in particular can be, wireless LANs (WLAN).

This document describes a method in which a network appliance 130 automatically receives a network access, if applicable a full network access, and at least one access to a remote network unit 102 (e.g. to a network unit 102 of a manufacturer of the appliance 130). A network access automatically set up in this way can be used by the network unit 102 to provide one or more services, such as e.g. a firmware update of the appliance 130. This can if applicable be set up and/or offered automatically without interaction with the user, e.g. during initial commissioning of the appliance 130 (if applicable not until after the user has given consent).

In particular in an urban environment (e.g. in a multi-family house) it may be advantageous at least in a first step as needed to enable access to the network unit 102 via an auxiliary LAN 111, e.g. via a neighbor's LAN 111. Thus the available network coverage can be extended for the incorporation of the appliance 130. In this case the auxiliary access point 110 can be restricted to enabling the connection of the appliance 130 to the network unit 102.

In a further step the appliance 130 can be linked to one or more user accounts of the user (on the network unit 102) using a method such as the OAUTH (Open Authorization) Device Grant. In this case the appliance 130 can if applicable also receive access information to the user's network infrastructure, in particular to the access point 120. In particular the appliance 130 can be incorporated into the user's LAN 121. The previously possibly isolated and/or restricted (W)LAN access via the auxiliary access point 110 can thereby be converted to an unrestricted access of the appliance 130 via a second access point 120. The appliance 130 is then a fully-fledged authenticated network appliance in the user's (W)LAN 121.

A method is thus described with which a network-compatible appliance 130 can if applicable be initially incorporated into an (auxiliary) network 111 without any interaction with a user and automatically receives one or more authorizations to access a particular resource 102, e.g. a particular computer on the Internet. In particular it is in this case possible to tell a user which appliance 130 has access to which resource 102.

An infrastructure for private keys, by which certificates are issued, can be provided by an entity, e.g. by the manufacturer of an appliance 130 or by the Wi-Fi Alliance. The certificates issued in this case preferably correspond to a widespread standard, e.g. x.509. Certificates (suitably encoded) can then be filed on the components involved, in particular on one or more appliances 130 and at one or more access points 110, 120. Private keys can be securely filed on what are known as trusted platform modules (TPM), and can if applicable be generated on the respective TPMs.

Within the PKI (Public Key Infrastructure) there exists if applicable just one root certificate with a working life that is as long as possible, e.g. 30 years. All other certificates can be derived from the root certificate via one or more intermediate certificates (if applicable also on a multistage basis). Thus for different groups of appliances 130 (e.g. for different manufacturers of appliances 130) a certificate tree can be created in each case, which is unique for the appliances 130 in the respective group, and the leaves of which can be assigned to particular subtrees (e.g. “Factory 1”, “Factory 2”, . . . ). The certificate tree of an entity (e.g. of a manufacturer) can in this case have a root certificate, from which all certificates of the group of appliances 130 of the entity are derived.

The certificates and/or intermediate certificates can be created with suitable metadata, by which for example information on the respective issuing body of the respective certificate is provided.

Using suitable protocols and/or services, such as OCSP (Online Certificate Status Protocol) responding and/or OCSP stapling, the validity of a certificate can be checked at any time. Furthermore, the exchange of certificates in different network appliances 130 can be implemented using suitable methods, if applicable standardized methods.

A network appliance 130 can, e.g. during manufacture, be equipped with a digital identity and with at least one certificate. The certificate can in this case be signed by one of the intermediate certificates of the corresponding subtree of the certificate tree and filed securely in the appliance together with the private key inside a suitable store (e.g. a TPM).

Furthermore, the certificate chain up to the root certificate or up to a reference certificate derived from the root certificate can be filed in the appliance 130, and can for example be converted to an access point 110, 120 during the connection setup, or can be made known to the access point 110, 120 via a different mechanism. It is also possible to store information in the certificate of the appliance 130 about the Internet address via which the respective root certificate can be retrieved.

The root certificate or the reference certificate derived from the root certificate for a group of appliances 130 can be provided in one or more access points or routers 110, 120. In particular the manufacturers participating in the system 100 or the Wi-Fi Alliance can in a suitable manner transfer copies of their respective root certificate (or reference certificates derived therefrom) into the access points or routers 110, 120. Similarly to the certificate store of a web browser, an access point 110, 120 thus receives information about trust relationships, which if applicable can already be set during the manufacture of the access point 110, 120.

FIG. 2a shows an exemplary list 200 containing one or more root or reference certificates 201 for corresponding one or more entities (e.g. manufacturers). For each entity in this case if applicable at least one network unit 102 (e.g. at least one Internet server) that can be accessed via the access point 110, 120 can be indicated in the list 200. The one or more network units 102 can be contained in the list 200 in a field 202 for access rights.

FIG. 2b shows an exemplary certificate chain 210 containing one or more intermediate certificates 212 between the appliance reference certificate 211 of an entity and the certificate 213 of the appliance 130. The certificate chain 210 can be stored on the appliance 130. All intermediate certificates 212 and the appliance certificate 213 are derived sequentially from the appliance reference certificate 211. The appliance reference certificate 211 of an entity (e.g. of an appliance manufacturer) can for example be the root certificate of the entity. As shown by the arrows in FIG. 2b, different appliance certificates 213 for different appliances 130 can be derived from the reference certificate 211 and/or from an intermediate certificate 212.

As soon as an appliance 130 is supplied with power, it can if applicable start searching, using a suitable method, e.g. the device provisioning protocol (DPP), for a suitable access point 110 in which the root or reference certificate 201, 211 to the certificate 213 of the appliance 130 is saved. The exact procedure is in this case predetermined by the respectively used protocol.

If a suitable access point 110 is found, a secure LAN connection 112 to the access point 110 can be created with the help of the public key and the respective certificate chain 210 can be transferred. The certificate chain 210 provided in this case has sufficient depth to enable the access point 110 to assign the certificate chain 210 provided by the appliance 130 to an internally present root certificate 201. If the certificate chain 210 could be successfully assigned, at least one resource 102 can be released for the appliance 130.

As soon as a connection has been established between the appliance 130 and the access point 110 at network level, the appliance 130 to be integrated into the network 111 can be provisioned with dynamically established data for higher protocol levels. The authorization required for this can for example be provided by a shared secret (which however requires the prior exchange of the secret, e.g. a password).

If a root or reference certificate 201, 211 is known to the access point 110 it is possible for access authorization to be granted automatically (without any prior exchange of a secret). Thus a connection setup can be enabled in a particularly convenient and efficient manner. In particular the connection 112 to the access point 110 can be set up automatically after the appliance 130 is switched on, and the access point 110 then automatically grants access to higher protocols and/or access to one or more particular routing destinations 102.

In particular a network appliance 130 of a manufacturer known to the access point 110 can be released automatically for (at least or precisely) one network unit 102 on the Internet e.g. explicitly specified in the root or reference certificate 201, 211. No user interaction is needed in this case for access to the network unit 102. On the other hand, access to another resource, e.g. the local internal network 110 and/or other destinations/end points on the Internet can be prevented.

For example, in an x.509 extension of the root or reference certificate 201, 211 it is possible to record which one or more Internet addresses (“domain names”) the appliances 130 of a particular root certification body or of a particular entity should have access to. The access can then be restricted by the access point 110 to the explicitly specified Internet addresses. Data traffic from an appliance 130 to other addresses or via other protocols can then automatically be rejected by the access point 110.

If an appliance 130 that is not authorized via the list 200 of known certification bodies stored at the access point 110 attempts a connection setup to the access point 110, the data traffic of the appliance 130 can be automatically blocked by the access point 110. Alternatively or additionally the user can be offered a choice as to whether the appliance 130 in question should be authorized manually.

If multiple access points 110, 120 with corresponding authorization are located in the range of the appliance 130, the appliance 130 can in accordance with a suitable method (e.g. as a function of the highest signal strength in each case and/or the highest data rate in each case) opt for the preferred access point 110, 120. In this case it is also possible, if applicable, for an access point 110, 120 to be chosen that is not operated by the user (but by a neighbor, for example).

Following on from a (restricted) incorporation into a first LAN 111 a subsequent incorporation into a further second LAN 121 can take place (e.g. in order to enable unrestricted incorporation and/or unrestricted access). The second LAN 121 can in this case be the LAN operated by the user. WPS (Wi-Fi Protected Setup) can be used for this purpose, the Wi-Fi password can be entered and/or if applicable any other method such as Captive Portal and Soft Access Point can be used.

In a preferred example a user account in which e.g. the access point 120 of the user is registered can be provided to the user on the network unit 102. In the user account it is possible to manage an access point assignment including the access data for the one or more network appliances 130 of the user to a particular access point 120. In this case it may be possible to incorporate into the user account an appliance 130 that is initially connected to the network unit 102 via an external access point 110. To this end for example the OAUTH Device Grant method can be used.

As soon as the link between the appliance 130 and the user account has been set up, the network unit 102 can select a suitable access point 120 for the appliance 130 (e.g. as a function of the signal strength of the possible access points 120 observed by the network appliance 130). The access data required for the access to the selected access point 120 can then be transferred to the network appliance 130. The appliance 130 can then automatically connect to the access point 120.

Alternatively or additionally to an automatic provision of a root or reference certificate 201, 211 and an access right, linked thereto, to a network unit 102, a user can be enabled to configure an access point 110, 120 manually (via a user interface). For example, a user can be enabled to access an access point 110, 120 (for instance via a LAN connection 124) via a user device 140 (e.g. a smartphone or a computer), in order to edit the list 200 containing one or more root or reference certificates 201, 211 and/or containing entries 202 for the access rights to one or more network units 102.

An access point 110, 120 can for example make an overview available to the user (e.g. via the user interface), e.g. containing the following information and/or containing the following options:
the one or more installed root or reference certificates 201 can be indicated;
one or more parameters for each root or reference certificate 201 or authorizations required for this can be indicated, e.g. end point(s) 102 on the Internet, data rate, services, protocols, required resources, etc.;
an option of editing, imposing or canceling one or more restrictions per network appliance 130:
   access to particular end points 102, e.g. the infrastructure of the manufacturer;
   protocols (IP*, http*, . . . );
   services (e.g. a time server);
   further parameters (data rate, time restrictions of the access, . . . );
a status for each network appliance 130 can be indicated, e.g. connection active, current data rate, accumulated data volume, services used (“manufacturer backend”, “time server”, . . . ), error statuses (“root or reference certificate expired”, . . . ); and/or
a general setting can be made, such as for instance a notification setting if a new appliance 130 has been connected using the described method or desires a connection setup.

This information can if applicable be retrievable in the local network 111, 121 using methods and protocols, e.g. uPNP or HTTP, and can if applicable be evaluated and amended by suitable agents, mobile devices 140, web browsers or the like.

Thanks to the measures described in this document a user of an appliance 130 can be enabled to incorporate the appliance 130 into a LAN 111, 121 in a particularly convenient and secure manner, and if applicable to connect to a network unit 102 in a WAN (e.g. for maintenance activities, for a firmware update, etc.).

FIG. 3a shows a flow diagram of an exemplary method 300 for incorporating an appliance 130, in particular a household appliance, such as a food processor, an oven, a washing machine, a stove, a refrigerator, a dishwasher, a dryer, etc., into a local area network (LAN) 111, and if applicable via it into a WAN. The method 300 can be executed by an access point 110 (in particular by a router) to a LAN 111. The access point 110 can in this case be designed to provide a wireless LAN (WLAN).

The appliance 130 can have a certificate 213 that was derived from an appliance reference certificate 211. In this case the certificate 213 of the appliance 130 can be generated from the appliance reference certificate 211 via a certificate chain 210 (containing one or more intermediate certificates 212). The appliance 130 can be designed to provide the certificate chain 210. The certificate 213 of the appliance and the certificate chain 210 potentially provided can be stored on a trusted platform module (TPM) of the appliance 130.

The method 300 comprises checking 301 whether the certificate 213 of the appliance 130 matches at least one reference certificate 201 available at a first access point 110 to a first LAN 111. In particular, it is possible to check whether the appliance reference certificate 211 of the entity (i.e. the reference certificate 201, 211 from which the certificate 213 of the appliance 130 was derived) is available at the first access point 110. A list 200 containing one or more reference certificates 201 (e.g. for corresponding one or more manufacturers of appliances 130) can be stored on a storage unit, in particular on a TPM, of the first access point 110. For each reference certificate 201, at least one network unit 102 can be specified (as a list entry 202) for which access is made possible via the first access point 110 if the appliance 130 has a certificate 213 matching the respective reference certificate 201. Access points 110 (in particular routers) can thus be provided, which for selected appliances 130 enable automatic (limited) LAN access and if applicable Internet access.

The method 300 further comprises the incorporation 302 of the appliance 130 into the first LAN 111, if (if applicable only if) it is determined that the certificate 213 of the appliance 130 matches at least one reference certificate 201 available at the first access point 110. The incorporation 302 can in this case take place automatically, without the user of the appliance 130 having to make an entry. Thus convenient and secure access to a LAN 111 and/or to a network unit 102 in a WAN can be enabled.

FIG. 3b shows a flow diagram of an exemplary method 310 for incorporating an appliance 130 into a LAN 111, 121 and/or into a WAN. The method 310 can be executed by the appliance 130 in a manner complementary to the method 300. The appliance 130 in this case has a certificate 213 that was derived from an appliance reference certificate 211 of an entity.

The method 310 comprises the identification 311 of a first access point 110 for a first LAN 111 at which a reference certificate 201 of an entity is available that matches the certificate 213 of the appliance 130, in particular that corresponds to the appliance reference certificate 211. For this purpose the appliance 130 can if applicable contact multiple different access points 110, 120. Then in each case the certificate 213 of the appliance 130 (in particular the certificate chain 210 of the appliance 130) can be sent to the respective access point 110, 120. The respective access point 110, 120 can then check whether the reference certificate 201 (in particular the appliance reference certificate 211) matching the certificate 213 201 is available at the respective access point 110, 120. The process of the identification 311 of a suitable access point 110 can in this case be initiated automatically by the appliance 130 (without any input by the user), for example during commissioning of the appliance 130.

The method 310 further comprises the incorporation 312 of the appliance 130 into the first LAN 111 via the (identified) first access point 110. Thus convenient and secure access to a LAN 111 (in particular a WLAN) can be enabled.

The present invention is not restricted to the exemplary embodiments shown. In particular it should be noted that the description and the figures are only intended to illustrate the principle of the proposed methods and apparatuses.

1-15. (canceled)

16. A method for incorporating an appliance into a first local area network (LAN), the appliance having a certificate derived from an appliance reference certificate, which comprises the steps of:
checking whether the certificate of the appliance matches at least one reference certificate that is available at a first access point to the first LAN; and
incorporating the appliance into the first LAN if it is determined that the certificate of the appliance matches the at least one reference certificate available at the first access point.

17. The method according to claim 16, wherein a list containing at least the at least one reference certificate is available at the first access point, the method further comprises:
determining whether or not the at least one appliance reference certificate is included in the list containing at least the at least one reference certificate; and
incorporating the appliance into the first LAN if it is determined that the appliance reference certificate is included in the list containing at least the at least one reference certificate.

18. The method according to claim 17, wherein the list containing at least the at least one reference certificate is stored on a storage unit of the first access point.

19. The method according to claim 16, wherein:
during the checking step checking, on a basis of the certificate of the appliance, whether the appliance reference certificate is available at the first access point; and
incorporating the appliance into the first LAN via the first access point if it is determined that the appliance reference certificate is available at the first access point.

20. The method according to claim 19, which further comprises:
determining at least one network unit for which an access authorization of the appliance via the first LAN is present; and
restricting an incorporation of the appliance into the first LAN to access to the at least one network unit.

21. The method according to claim 20, wherein the at least one network unit is disposed in a wide area network outside the first LAN and the method further comprises providing a communication link between the appliance and the at least one network unit via the first access point.

22. The method according to claim 20, wherein:
the list containing at least the at least one reference certificate is available at the first access point; and
the list indicates for each said reference certificate in each case the at least one network unit for which appliances that have the certificate matching the reference certificate have an access authorization.

23. The method according to claim 16, which further comprises:
determining an appliance certificate chain between the certificate of the appliance and the appliance reference certificate, wherein the appliance certificate chain indicates at least one intermediate certificate between the certificate of the appliance and the appliance reference certificate; and
checking, on a basis of the appliance certificate chain, whether the certificate of the appliance matches the at least one reference certificate that is available at the first access point to the first LAN.

24. The method according to claim 16, which further comprises:
determining a network unit for which an access authorization of the appliance via the first LAN is present, wherein the network unit indicates at least one second access point to a second LAN; and
setting up a communication link between the appliance and the network unit via the first access point, in order to enable the appliance to obtain access data to the second access point from the network unit.

25. The method according to claim 18, wherein the storage unit is a trusted platform module of the first access point.

26. The method according to claim 16, wherein during the checking step checking, on a basis of the certificate of the appliance, whether the appliance reference certificate is stored on a storage unit of the first access point.

27. The method according to claim 21, wherein the communication link between the appliance and the at least one network unit via the first access point is performed via a router of the first access point.

28. A method for incorporating an appliance into a first local area network (LAN), the appliance having a certificate derived from an appliance reference certificate, which comprises the steps of:
identifying a first access point for the first LAN at which a reference certificate is available that matches the certificate of the appliance; and
incorporating the appliance into the first LAN via the first access point.

29. The method according to claim 28, which further comprises:
accessing a network unit via the first access point, wherein the network unit indicates at least one second access point to a second LAN; and
obtaining access data to the second access point from the network unit.

30. The method according to claim 29, which further comprises:
incorporating the appliance into the second LAN via the second access point using the access data to the second access point; and/or
logging off the appliance from the first access point.

31. The method according to claim 28, which further comprises:
setting up a communication link to a network unit via the first access point; and
carrying out maintenance work on the appliance by access of the network unit to the appliance via the first access point.

32. The method according to claim 28, wherein the reference certificate corresponds to the appliance reference certificate.

33. An access point to a local area network (LAN), wherein the access point is configured to:
check whether a certificate of an appliance that is to be incorporated into the LAN matches a reference certificate that is available at the access point; and
incorporate the appliance into the LAN if it is determined that the certificate of the appliance matches a reference certificate available at the access point.

34. An appliance having a certificate derived from an appliance reference certificate, wherein the appliance is configured to:
identify a first access point for a first LAN at which a reference certificate is available that matches the certificate of the appliance; and
in response thereto, to effect an incorporation into the first LAN via the first access point.
